(19) United States
(12) Patent Application Publication
(10) Pub. No.: US 2019/0055496 A1
(43) Pub. Date: Feb. 21, 2019

(54) METHOD OF CLEANING HOUSEHOLD SURFACES

(71) Applicant: The Procter & Gamble Company, Cincinnati, OH (US)

(72) Inventors: Scott Leroy CRON, Liberty Township, OH (US); Geert Andre DELEERSNYDER, Wielsbeke (BE); Patrick Firmin August DELPLANCKE, Steenhuize-Wijnhuize (BE); Neil Thomas FAIRWEATHER, Liberty Township, OH (US); Cedric Joseph VOLONT, Laken (BE); Ryan Michael WEST, West Chester, OH (US)

(21) Appl. No.: 16/059,064

(22) Filed: Aug. 9, 2018

Related U.S. Application Data
(60) Provisional application No. 62/546,045, filed on Aug. 16, 2017.

(30) Foreign Application Priority Data
Aug. 28, 2017 (EP) 17 188 062.8

(51) Int. Cl. C11D 3/30; C11D 3/22; C11D 1/75; C11D 11/00

(52) U.S. Cl. CPC C11D 3/30; C11D 11/0023; C11D 1/75; C11D 3/221

(57) ABSTRACT

The need for a method of cleaning household surfaces which results in less grease residues on the surface, and improved surface shine is met by cleaning the household surface using an aqueous hard surface cleaning composition which comprises specific amines.

### FIELD OF THE INVENTION

Method of cleaning household surfaces using hard surface cleaning compositions comprising amines.

### BACKGROUND OF THE INVENTION

Hard surface cleaning compositions are used for cleaning and treating hard surfaces. Preferably, the hard surface cleaning composition is formulated to be an “all purpose” hard surface cleaning composition. That is, the hard surface cleaning composition is formulated to be suitable for cleaning as many different kinds of surfaces as possible.

After cleaning household surfaces, the user expects the treated surfaces to be grease-free and shiny. Indeed, the relative shine is considered to be an indication of surface cleanliness. However, shine impression is reduced by the smearing of residues on the surface. Such residues can be residual oils. Moreover, by maintaining shine, less frequency of cleaning is needed. As such, a need remains for a method of cleaning household surfaces which results in less grease residues on the surface, and improved surface shine.

EP application 16184415.4 relates to a hand dishwashing cleaning composition comprising a surfactant system and an amine of formula: R1-N—(R2)(CH2CHOH(CH2O)nR3), wherein R1 and R2 are independently selected from hydrogen, cyclic or acyclic, linear or branched C1 to C10 alkyl, C1 to C10 hydroxyalkyl, polyhydroxyhydrocarbyl and polyalkoxy of formula (R4-O)xH with R4 being C1-C4 and x is from 1 to 15; n is 0 or 1, preferably 1; and R3 is a C6 to C30 hydrocarbyl. WO2015120990 relates to the use of N-methyl-N-acylglucamines in compositions for cleaning hard surfaces, having a pH value <6, the proportion of the glucamines with C8-C14-acyl groups being at least 80 wt. % and the proportion of glucamines with C8-C10-acyl groups is more than 50 wt. %, respectively in relation to the total amount of glucamines. EP3077493 relates to compositions containing: at least one N-alkyl-N-acyl glucamine; at least one fatty acid and/or soap; at least one acyl isethionate; sodium isethionate; and water, with more than 20 weight percent, preferably more than 70 weight percent of the N-alkyl-N-acyl glucamines containing at least one C12- and/or C14- and/or C16- and/or C18-acyl group, and such compositions being useful as soap bars. EP2855650 relates to a clear composition which contains at least one anionic surfactant, a betaine surfactant, an N-methyl-N-acylglucamine, a triglyceride oil, a solvent and optionally an additive, a method for producing such compositions, and the use of such compositions for the treatment or care of skin or hair, or for use as a shampoo, face cleaner, liquid cleaner or shower gel. EP2855651 relates to a composition which contains at least one anionic surfactant, a betaine surfactant, a mixture of N-methyl-N-acylglucamines, the acyl groups of which correspond to those of natural coconut oil and/or palm kernel oil, a glycerol derivative, a solvent and optionally one or more additives, as well as to a method for producing the composition, and the use of the composition for the treatment or care of skin or hair, for example as a shampoo, face cleaner, liquid cleaner or shower gel. EP2855649 relates to a surfactant concentrate which contains at least one anionic surfactant, an N-methyl-N-acylglucamine, a solvent and optionally one or more additives, as well as to a method for producing the surfactant concentrate, and a method for producing cosmetic, dermatological or pharmaceutical compositions. EP2866895 relates to a surfactant solution containing: a mixture of N-methyl-N-oleylglucamine, N-methyl-N—C12-C14-acylglucamines, other N-methyl-N-acylglucamines; one or more alcohols; water; and additives. EP2855647 relates to a composition which contains one or more N-methyl-N-acylglucamines; at least 80 wt. % of the N-methyl-N-acylglucamines having a saturated or unsaturated C16-, C17- and/or C18-acyl group; one or more fatty alcohols; one or more cationic surfactants; optionally other additives; and water, the composition being suitable for producing cosmetic, dermatological and pharmaceutical emulsions, especially for use in hair care products. EP2854951 relates to a composition which contains at least one N-acyl-amino acid surfactant, a betaine surfactant, an N-methyl-N-acylglucamine, said N-methyl-N-acylglucamine having a C16-C20-acyl group, and further contains a solvent, as well as to a method for producing the composition, and the use of the composition for the treatment or care of skin or hair, or for use as a shampoo, face cleaner, liquid cleaner or shower gel. EP3013429 relates to certain N-alkyl-N-acylglucamines suitable as a component in skin-cleaning agents and hand dishwashing agents, which comprise an aqueous surfactant system with at least one anionic surfactant. EP3114255 relates to a composition comprising at least one N-methyl-N-acylglucamine having a linear or branched, saturated or unsaturated hydrocarbon chain with 7 to 21 carbon atoms, one or more organic acids, having a linear or branched alkyl group or a linear or branched mono- or poly-unsaturated alkenyl group with 5 to 29 carbon atoms, and one or more alkanolamines, with at least one having a hydroxyalkyl group or a hydroxyether group. EP2854751 relates to the use of N-methyl-N—C8-C14-acylglucamines as solubilizers in cosmetic preparations, and to clear lotions for the preparation of wet wipes, the lotions comprising the N-methyl-N—C8-C14-acylglucamines, one or more water-insoluble or only partially water-soluble anti-microbial agents, one or more oils, water, surfactants, and optionally additional auxiliaries and additives. EP3013427 relates to N-alkyl-N-acylglucamines which exhibit in hair-washing agents comprising an aqueous surfactant system with at least one anionic surfactant, a hair-conditioning effect.

### SUMMARY OF THE INVENTION

The present invention relates to a method for cleaning household surfaces using an aqueous hard surface cleaning composition comprising amines, as described in present claim 1. The present invention further relates to the use of such amines in aqueous hard surface cleaning compositions, for removing grease from household surfaces and/or improving the shine of household surfaces.

### DETAILED DESCRIPTION OF THE INVENTION

The present method, using a hard surface cleaning composition comprising an amine, results in less grease residues on the treated surface, and improved surface shine.

As defined herein, “essentially free of” a component means that no amount of that component is deliberately incorporated into the respective premix, or composition. Preferably, “essentially free of” a component means that no amount of that component is present in the respective premix, or composition.

As used herein, “isotropic” means a clear mixture, having little or no visible haziness, phase separation and/or dispersed particles, and having a uniform transparent appearance.

As defined herein, “stable” means that no visible phase separation is observed for a composition kept at 25° C. for a period of at least two weeks, or at least four weeks, or greater than a month or greater than four months, as measured using the Floc Formation Test, described in USPA 2008/0263780 A1.

All percentages, ratios and proportions used herein are by weight percent of the composition, unless otherwise specified. All average values are calculated “by weight” of the aqueous hard surface cleaning composition, unless otherwise expressly indicated.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

Method of Cleaning a Household Surface:

The liquid hard surface cleaning compositions described herein are suitable for cleaning household surfaces. In particular, such compositions are particularly useful for removing grease and improving shine on such household surfaces.

Household surfaces to be cleaned include kitchens and bathrooms, e.g., floors, walls, tiles, windows, cupboards, sinks, showers, shower plastified curtains, wash basins, WCs, fixtures and fittings, and the like made of different materials like ceramic, vinyl, no-wax vinyl, linoleum, melamine, glass, steel, kitchen work surfaces, any plastics, plastified wood, metal, wood such as wood floors and wood furniture, or any painted or varnished or sealed surface and the like.

Household hard surfaces also include household appliances including, but not limited to refrigerators, freezers, washing machines, automatic dryers, ovens, microwave ovens, dishwashers and so on. Such hard surfaces may be found both in private households as well as in commercial, institutional and industrial environments. Particularly suited household surfaces are those which are fixedly attached or generally immovable, for instance, not including dishware or cutlery.

The method of cleaning comprises the steps of:
a) optionally diluting the aqueous hard surface cleaning composition, as described herein;
b) applying the hard surface cleaning composition to the household surface; and
c) optionally rinsing and/or wiping the surface;

For general cleaning, especially of floors, the aqueous hard surface cleaning composition is preferably diluted, for instance, to a level of from 0.3% to 2.0% by volume, or from 0.35% to 1.0%, or from 0.4% to 0.6% by volume.

The dilution level is expressed as a percent defined as the fraction of the liquid hard surface cleaning composition, by volume, with respect to the total amount of the diluted composition. For example, a dilution level of 5% by volume is equivalent to 50 ml of the liquid hard surface cleaning composition being diluted to form 1000 ml of diluted composition.

The diluted composition can be applied by any suitable means, including using a mop, sponge, or other suitable implement.

Alternatively, and especially for particularly dirty or greasy spots, the liquid hard surface cleaning compositions can be applied neat to the hard surface.

By “neat”, it is to be understood that the liquid composition is applied directly onto the surface to be treated without undergoing any significant dilution, i.e., the liquid composition herein is applied onto the hard surface as described herein, either directly or via an implement such as a sponge, without first diluting the composition. By significant dilution, what is meant is that the composition is diluted by less than 10 wt %, preferably less than 5 wt %, more preferably less than 3 wt %. Such dilutions can arise from the use of damp implements to apply the composition to the hard surface, such as sponges which have been “squeezed” dry.

In the method of the present invention, the aqueous hard surface cleaning composition can be applied to the household surface neat, for instance, when the aqueous hard surface cleaning composition is formulated as a spray composition. Such methods comprise the steps of applying, preferably spraying, said liquid composition onto said hard surface, leaving said liquid composition to act onto said surface for a period of time to allow said composition to act, with or without applying mechanical action, and optionally removing said liquid composition, preferably removing said liquid composition by rinsing said hard surface with water and/or wiping said hard surface with an appropriate instrument, e.g., a sponge, a paper or cloth towel and the like.

The hard surface cleaning composition can also be comprised on a wipe or pad. Such wipes and pads can be suitable for cleaning hard surfaces, such as found in the household, automotive surfaces such as car glass, and the like. Suitable wipes can be fibrous. Suitable fibrous wipes can comprise polymeric fibres, cellulose fibres, and combinations thereof. Suitable cellulose-based wipes include kitchen wipes, and the like. Suitable polymeric fibres include polyethylene, polyester, and the like. Polymeric fibres can be spun-bonded to form the wipe. Methods for preparing thermally bonded fibrous materials are described in U.S. application Ser. No. 08/479,096 (Richards et al.), filed Jul. 3, 1995 (see especially pages 16-20) and U.S. Pat. No. 5,549,589 (Horney et al.), issued Aug. 27, 1996 (see especially Columns 9 to 10). Suitable pads include foams and the like, such as HIPE-derived hydrophilic, polymeric foam. Such foams and methods for their preparation are described in U.S. Pat. No. 5,550,167 (DesMarais), issued Aug. 27, 1996; and commonly assigned U.S. patent application Ser. No. 08/370,695 (Stone et al.), filed Jan. 10, 1995.

Liquid Hard Surface Cleaning Compositions:

By “liquid hard surface cleaning composition”, it is meant herein a liquid composition for cleaning hard surfaces found, for example, in households, especially domestic households.

The liquid compositions herein are aqueous compositions. Therefore, they may comprise from 30% to 99.5% by weight of the total composition of water, preferably from 50% to 98% and more preferably from 80% to 97%.

For “all purpose” hard surface cleaning compositions, the pH is preferably from 7.0 to 12, more preferably from 7.5 to 11.5, even more preferably from 9.5 to 11.3, most preferably 10 to 11. It is believed that the greasy soil and particulate greasy soil cleaning performance is further improved at these preferred alkaline pH ranges. Accordingly, the compositions herein may further comprise an acid or base to adjust pH as appropriate.

A suitable acid, especially for use in alkaline aqueous hard surface cleaning compositions, is an organic and/or an inorganic acid. A preferred organic acid for use herein has a pKa of less than 6. A suitable organic acid is selected from the group consisting of: citric acid, lactic acid, glycolic acid, succinic acid, glutaric acid and adipic acid and mixtures thereof. A suitable inorganic acid can be selected from the group consisting of: hydrochloric acid, sulphuric acid, phosphoric acid and mixtures thereof. A typical level of such acids, when present, is from 0.01% to 5.0% by weight of the total composition, preferably from 0.04% to 3.0% and more preferably from 0.05% to 1.5%.

A suitable base, especially for use in alkaline aqueous hard surface cleaning compositions, is an organic and/or inorganic base. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide. Other suitable bases include ammonia, ammonium carbonate, K₂CO₃, Na₂CO₃ and alkanolamines (such as monoethanolamine, triethanolamine, aminomethylpropanol, and mixtures thereof). Typical levels of such bases, when present, are from 0.01% to 5.0% by weight of the total composition, preferably from 0.05% to 3.0%, more preferably from 0.1% to 2.0%, and most preferably 0.5% to 2.0%.

The hard surface cleaning compositions of the present invention do not comprise enzymes, and are hence typically unsuitable for cleaning fabrics and the like.

For improved limescale removal, an acidic pH is preferred. Therefore such acidic hard surface cleaning compositions have a pH of less than 7. Preferably, the composition has a pH of from 1 to 6, more preferably from 1.5 to 4.0, still more preferably from 2.0 to 3.7, and most preferably from 2.1 to 2.4. The pH of the cleaning compositions is measured at 25° C.

For acidic cleaners, the acid system may comprise any organic or inorganic acid well-known to those skilled in the art, or a mixture thereof. In preferred embodiments, the acid system comprises acids selected from the group consisting of: citric acid, formic acid, acetic acid, maleic acid, lactic acid, glycolic acid, succinic acid, glutaric acid, adipic acid, sulphamic acid, sulphuric acid, hydrochloric acid, phosphoric acid, nitric acid, methane sulphonic acid, and mixtures thereof, preferably acids selected from the group consisting of: citric acid, formic acid, acetic acid, lactic acid, phosphoric acid, and mixtures thereof. Formic acid is particularly preferred as part of the acid system for acidic cleaning compositions. Formic acid has been found to provide excellent limescale removal performance, in combination with improved surface safety, especially for surfaces which are prone to corrosion. Citric acid is particularly preferred for alkaline aqueous cleaning compositions.

The acidic composition preferably comprises the acid system at a level of from 0.01% to 15%, preferably from 0.5% to 10%, more preferably from 2% to 8%, most preferably from 4% to 7.5% by weight of the total composition.

Acidic hard surface cleaning compositions can also comprise an alkaline material, so long as the overall pH remains acidic. Examples of alkaline material are sodium hydroxide, potassium hydroxide and/or lithium hydroxide, and/or the alkali metal oxides such, as sodium and/or potassium oxide or mixtures thereof and/or monoethanolamine and/or triethanolamine. Other suitable bases include ammonia, ammonium carbonate, choline base, etc. Preferably, source of alkalinity is sodium hydroxide or potassium hydroxide, preferably sodium hydroxide. Typically the amount of alkaline material is of from 0.001% to 20% by weight, preferably from 0.01% to 10% and more preferably from 0.05% to 3% by weight of the composition.

Amine:

The aqueous hard surface cleaning compositions of use in the method of the present invention comprises an amine selected from the group consisting of:
i. an amine of formula I:

R1-N—R2R3 formula I
wherein:
R1 is a cyclic or acyclic polyhydroxyhydrocarbyl;
R2 is hydrogen or methyl; and
R3 is a C6 to C30 hydrocarbyl, preferably C6 to C30 alkyl, hydroxyalkyl, alkoxyalkyl, cycloalkyl, aralkyl or alkenyl;
ii. an amine of formula II:

R1-N—R2R3 formula II
wherein:
R1 is an acyclic or cyclic polyhydroxyhydrocarbyl; and
R2 and R3 are independently selected from:
   hydrogen, wherein R2 and R3 are not both hydrogen;
   substituted or unsubstituted C1 to C5 hydrocarbyl, preferably C1 to C3 hydrocarbyl; and
   acyclic or cyclic polyhydroxyhydrocarbyl as defined for R1;
iii. an amine of formula III:

R1-N—(R2)(CH2CHOH(CH2O)nR3) formula III
wherein:
R1 and R2 are independently selected from hydrogen, cyclic or acyclic, linear or branched C1 to C10 alkyl, C1 to C10 hydroxyalkyl, polyhydroxyhydrocarbyl, and polyalkoxy of formula (R4-O)xH with R4 being C1-C4 and x is from 1 to 15;
preferably x is from 1 to 5, more preferably x is 1;
n is 0 or 1, preferably 1; and
R3 is a C6 to C30 hydrocarbyl, preferably C6 to C30 alkyl, hydroxyalkyl, alkoxyalkyl, cycloalkyl, aralkyl or alkenyl;
iv. and mixtures thereof.

A “hydrocarbyl” is a univalent group formed by removing a hydrogen atom from a hydrocarbon, e.g. ethyl, phenyl.

A “polyhydroxyhydrocarbyl” is a hydrocarbyl with two or more hydroxyl (—OH) groups.

A “polyhydroxyhydrocarbylamine” is a polyhydroxyhydrocarbyl comprising an amine functionality.

It is believed that the amines as described herein improve the removal of polymerized grease and provide improved shine through improved surfactancy, solvency or a combination of both improved. surfactancy and solvency

In formula I, R1 is an acyclic or cyclic polyhydroxyhydrocarbyl, preferably a linear polyhydroxyhydrocarbyl group. Preferably R1 is a linear C3 to C8 chain with at least two hydroxyl groups, preferably a C4 to C7 chain with at least three hydroxyl groups directly bonded to the carbon atoms of the chain. R1 can include substituents, in particular, alkoxy groups e.g. by etherification of further hydroxyl groups or further polyhydroxyhydrocarbyl, e.g. polyhydroxy alkyl, group(s). R1 preferably includes at least three free hydroxyl groups including such hydroxyl groups on substituents of the basic carbon chain. Alternatively R1 can be selected from ring structures comprising an internal ether link, the ring comprising at least two or more hydroxyl groups, most preferably the hydroxyl groups are on a carbon atom not connected to the nitrogen in Formula (I). R1 can be an open chain tetratol, pentitol, hexitol or heptitol group or an anhydro e.g. cycloether anhydro derivative of such a group. Preferably R1 is the residue of, or a residue derived from a sugar, particularly a monosaccharide such as glucose, xylose, fructose or sorbitol; a disaccharide such as maltose or sucrose; or a higher oligosaccharide. Preferably, R1 is derived from a sugar of the group consisting of glucose, xylose, maltose and mixtures thereof.

Preferred R1 groups for the amine of formula I are derived from glycoses and are of the formula:

—CH2-(CHOH)4-CH2OH formula Ia,

e.g. corresponding to residues from glucose, mannose or galactose. It is specially preferred when R1 is derived from glucose. In this case the group —NR1 is of the formula:

—N—CH2-(CHOH)4-CH2OH formula Ib

and the group is conveniently called a glycamine group. Most preferably the group R1 will be derived from glucose and the corresponding amines may be called glucamines (as they will usually be made from glucose).

R2 is selected from hydrogen and methyl.

R3 is a C6 to C30 hydrocarbyl. R3 can be selected from the group consisting of linear and branched C6 to C30, preferably from C7 to C20, more preferably from C8 to C16, even more preferably from C8 to C14 and most preferably from C8 to C1O. R3 can be selected from C6 to C30 alkyl, hydroxyalkyl, alkoxyalkyl, cycloalkyl, aralkyl or alkenyl groups, preferably the alkyl group comprising from 6 to 30, preferably from 7 to 20, more preferably from 8 to 15, even more preferably from 8 to 12 and most preferably from 8 to 10 carbon atoms. The alkyl group can be linear or branched, preferably C1 to C4 branching, more preferably C1 to C3 branching on the 2- or 3-position, preferably 2-position. R3 can also be a substituted alkyl group e.g. a hydroxy or alkoxy substituted alkyl group, particularly a C6 to C30 alkyl group which is hydroxy substituted. The additional hydroxyl group or oxygen atom may provide a modest increase in water solubility. R3 can also be an aralkyl group, particularly a C7 to C12 aralkyl group, such as a benzyl group. Preferably R2 is selected from hydrogen and methyl and R3 from octyl and decyl.

Preferred amine compounds of formula I are linear or branched C6 to C10 glucamines, more preferably N-hexylglucamine, N-octylglucamine, N,N-methyl octylglucamine, N-decylglucamine, N,N-methyl decylglucamine, N-2-ethylhexyl glucamine, N,N-2-ethylhexyl methlylglucamine, N-2-propylheptyl glucamine and N,N-2-propylheptyl methylglucamine even more preferably N-decylglucamine, N-2-propylheptyl glucamine, N,N-methyl decylglucamine and N,N-2-propylheptyl methylglucamine.

For the amine of formula II, R1 is an acyclic or cyclic polyhydroxyhydrocarbyl, preferably a linear polyhydroxyhydrocarbyl group. Preferably R1 is a linear C3 to C8 chain with at least two hydroxyl groups, preferably a C4 to C7 chain with at least three hydroxyl groups directly bonded to the carbon atoms of the chain. R1 can include substituents, in particular, alkoxy groups e.g. by etherification of further hydroxyl groups or further polyhydroxyhydrocarbyl, e.g. polyhydroxy alkyl, group(s). R1 preferably includes at least three free hydroxyl groups including such hydroxyl groups on substituents of the basic carbon chain. Alternatively R1 can be selected from ring structures comprising an internal ether link, the ring comprising at least two or more hydroxyl groups, most preferably the hydroxyl groups are on a carbon atom not connected to the nitrogen in Formula (I). R1 can be an open chain tetratol, pentitol, hexitol or heptitol group or an anhydro e.g. cycloether anhydro derivative of such a group. Preferably R1 is the residue of, or a residue derived from a sugar, particularly a monosaccharide such as glucose, xylose, fructose or sorbitol; a disaccharide such as maltose or sucrose; or a higher oligosaccharide. Preferably, R1 is derived from a sugar of the group consisting of glucose, xylose, maltose and mixtures thereof.

Preferred R1 groups, for amines of formula II, are derived from glycoses and are of the formula:

—CH2-(CHOH)4-CH2OH formula IIa,

e.g. corresponding to residues from glucose, mannose or galactose. It is specially preferred when R1 is derived from glucose. In this case the group —NR1 is of the formula:

—N—CH2-(CHOH)4-CH2OH formula IIb,

and the group is conveniently called a glycamine group. Most preferably the group R1 will be derived from glucose and the corresponding amines may be called glucamines (as they will usually be made from glucose).

R2 and R3, for the amines of formula II, are independently selected from

i) hydrogen, preferably R2 and R3 are not hydrogen at the same time;

ii) substituted or unsubstituted C1 to C3 hydrocarbyl, particularly alkyl, hydroxyalkyl or alkoxyalkyl, in which the alkyl group comprises from 1 to 3, preferably from 1 to 2 carbon atoms; and

iii) polyhydroxyhydrocarbyl as defined for R1 in which case the amine function provides two or three hydrophilic polyhydroxy hydrocarbyl groups. In this case, the different groups of the formula R1, R2 and/or R3 will often be (but need not be) the same, as it is usually easier to make the symmetrical polyhydroxyhydrocarbyl substituted amine intermediate.

Especially preferred amine compounds of formula II are selected from the group consisting of N-methyl amino propane diol, N,N-dimethyl amino propane 1,2-diol, glucamine, N-methylglucamine, N,N-dimethylglucamine, N-ethylglucamine, N,N-diethylglucamine, N-2-hydroxyethylglucamine, and N,N-methyl 2-hydroxyethylglucamine, more preferably N-methylglucamine, N,N-dimethylglucamine, N-ethylglucamine, N,N-diethylglucamine, N-2-hydroxyethylglucamine, N,N-methyl 2-hydroxyethylglucamine and mixtures thereof, most preferably N-methylglucamine, N-ethylglucamine and N-2-hydroxyethylglucamine. Especially preferred amines for use herein are selected from the group consisting of N,N-dimethylglucamine, N,N-methyl 2-hydroxyethylglucamine and N-hydroxyethylglucamine, and mixtures thereof.

For amines of formula III, when R1 is a polyhydroxyhydrocarbyl, R1 is an acyclic or cyclic polyhydroxyhydrocarbyl, preferably a linear polyhydroxyhydrocarbyl. Preferably R1 is a linear C3 to C8 chain with at least two hydroxyl groups, preferably a C4 to C7 chain with at least three hydroxyl groups directly bonded to the carbon atoms of the chain. R1 can include substituents, in particular, alkoxy groups e.g. by etherification of further hydroxyl groups or further polyhydroxyhydrocarbyl, e.g. polyhydroxy alkyl, group(s). R1 preferably includes at least three free hydroxyl groups including such hydroxyl groups on substituents of the basic carbon chain. Alternatively R1 can be selected from ring structures comprising an internal ether link, the ring comprising at least two or more hydroxyl groups, most preferably the hydroxyl groups are on a carbon atom not connected to the nitrogen in Formula (I). R1 can be an open chain tetratol, pentitol, hexitol or heptitol group or an anhydro e.g. cycloether anhydro derivative of such a group.

For the amines of formula III, R1 can be a polyhydroxyhydrocarbyl derived from a sugar, preferably a sugar selected from the group consisting of: monosaccharide, disaccharide, or trisacchaside, though a monosaccharide is preferred. For instance, R1 can be the residue of, or a residue derived from a sugar, particularly a monosaccharide such as glucose, xylose, fructose or sorbitol; a disaccharide such as maltose or sucrose; or a higher oligosaccharide. While monosaccharides are preferred, disaccharides and trisaccharides can also be present, typically at the ratios present in the sugar from which the polyhydroxyhydrocarbyl is derived. Preferably, R1 is derived from a sugar of the group consisting of glucose, xylose, maltose and mixtures thereof. Preferred R1 groups, for the amines of formula III, are derived from glycoses and are of the formula:

—CH2-(CHOH)4-CH2OH formula IIIa,

for instance, corresponding to residues from monosaccharides such as glucose, mannose or galactose, preferably glucose. The aldehyde of the monosaccharide is typically eliminated during the reaction to bind the monosaccharide to the amine of formula I. It is specially preferred when R1 is derived from glucose. In this case the group —NR1 is of the formula:

—N—CH2-(CHOH)4-CH2OH formula IIIb,

and the group is conveniently called a glycamine group. Most preferably the group R1 will be derived from glucose and the corresponding amines may be called glucamines (as they will usually be made from glucose). The group R1 may comprise, one, two or more glucose units, and the resulting glucamine may be a mixture of monoglucamine (R1 comprises one glucose unit), diglucamine (R1 comprises two glucose units) and triglucamine (R1 comprises three glucose units).

When R1, for the amine of formula III, is a C1 to C10 alkyl, it is preferably an alkyl comprising from 1 to 5, more preferably from 1 to 4, even more preferably from 1 to 2 carbon atoms. Most preferably when R1 is not a polyhydroxyhydrocarbyl, it is hydrogen or methyl.

Most preferably R1 is a polyhydroxyhydrocarbyl.

R2, for the amines of formula III, is preferably selected from the group consisting of hydrogen and C1 to C10 alkyl, particularly when R1 is a polyhydroxyhydrocarbyl. R2 is preferably hydrogen or an alkyl group comprising from 1 to 5, more preferably from 1 to 4 and even more preferably from 1 to 2 carbon atoms. Most preferably R2 is hydrogen or methyl.

For the amines of formula III, when R1 is not a polyhydroxyhydrocarbyl, R1 and R2 are preferably independently selected from hydrogen or an alkyl group comprising from 1 to 5 preferably from 1 to 4 and even more preferably from 1 to 2 carbon atoms. Most preferably R1 and R2 are independently selected from hydrogen or methyl.

For the amines of formula III, R3 is a hydrocarbyl, preferably selected from C6 to C30 alkyl, hydroxyalkyl, alkoxyalkyl, cycloalkyl, aralkyl or alkenyl groups, preferably the alkyl group comprises from 6 to 30, preferably from 7 to 20, more preferably from 8 to 15, even more preferably from 8 to 12 and most preferably from 8 to 10 carbon atoms. The alkyl group can be linear or branched, preferably C1 to C4 branching, more preferably C1 to C3 branching on the 2- or 3-position, preferably 2-position. R3 can also be a substituted alkyl group e.g. a hydroxy or alkoxy substituted alkyl group, particularly a C6 to C30 alkyl group which is hydroxy substituted. The additional hydroxyl group or oxygen atom may provide a modest increase in water solubility. R3 can also be an aralkyl group, particularly a C7 to C12 aralkyl group, such as a benzyl group. R3 is can be selected from the group consisting of: C6 to C10 alkyl and mixtures thereof; preferably R3 is selected from the group consisting of hexyl, octyl, decyl, and mixtures thereof; more preferably R3 is decyl, octyl, and mixtures thereof; most preferably R3 is 2-propylheptyl, 2-ethylhexyl, and mixtures thereof.

The amine selected from amine compounds according to formula (III) can have the formula wherein:
R1 is a polyhydroxyhydrocarbyl which is preferably derived from a monosaccharide, more preferably glucose, and has the formula:

—CH2-(CHOH)4-CH2OH formula IIIa;
R2 is hydrogen or methyl; and
R3 is selected from the group consisting of: C6 to C10 alkyl and mixtures thereof;
preferably R3 is selected from the group consisting of hexyl, octyl, decyl, and mixtures thereof; more preferably R3 is decyl, octyl, and mixtures thereof; most preferably R3 is 2-propylheptyl, 2-ethylhexyl, and mixtures thereof.

Preferred amines of formula III include those in which n is 1, R1 is glucose as such forming a glucamine compound, R2 is methyl and R3 is hexyl, octyl or decyl.

When R3 is octyl, it is preferably selected from n-octyl, and 2-ethylhexyl. When R3 is decyl, it is preferably selected from n-decyl and 2-propylheptyl.

Other preferred amines of formula III are those in which n is 1, R1 and R2 are methyl and R3 is hexyl, octyl or decyl. When R3 is octyl, it is preferably selected from n-octyl and 2-ethylhexyl.

When R3 is decyl, it is preferably selected from n-decyl and 2-propylheptyl.

Mixtures of different amines can have benefits in terms of processing, solubility and performance.

While such amines can have a net positive charge at certain pH, they are typically referred to as nonionic surfactants. However, at low pH (below the pKa of the surfactant) they can have a net positive charge.

The compositions of use in the method of the present invention can comprise from 0.1% to 10% by weight of the composition of the amine, preferably from 0.1% to 5.0%, more preferably from 0.15% to 4.0%, most preferably from 0.3% to 3.0% by weight.

Detersive Surfactant:

The liquid hard surface cleaning composition can comprise a detersive surfactant. Suitable detersive surfactants can be selected from the group consisting of: anionic surfactants, nonionic surfactants, amphoteric surfactants, zwitterionic surfactants, and mixtures thereof. Preferred detersive surfactants are: anionic surfactants, nonionic surfactants, and mixtures thereof.

The total amount of detersive surfactant can be present at a level of from 0.00025 wt % to 20 wt %, preferably from 0.02 wt % to 12 wt %, more preferably from 0.05 wt % to 9.5 wt %, more preferably from 0.1 wt % to 5.0 wt %, most preferably from 0.15 wt % to 4.0 wt % of the composition.

Suitable nonionic surfactant can be selected from the group consisting of: alkoxylated nonionic surfactants, alkyl polyglycosides, amine oxides, and mixture thereof. Typically, the liquid hard surface cleaning composition may comprise from 0.00025 wt % to 20 wt % by weight of the total composition of said nonionic surfactant, preferably from 0.02 wt % to 12 wt %, more preferably from 0.05 wt % to 9.5 wt %, more preferably from 0.1 wt % to 6.5 wt %, and most preferably from 0.15 wt % to 4.0 wt %.

The hard surface cleaning composition can comprise from 0.00025 wt % to 10.0 wt % by weight of the total composition of alkoxylated alcohol, preferably ethoxylated alcohol, preferably from 0.002 wt % to 8.0 wt %, more preferably from 0.01 wt % to 6.5 wt % and most preferably from 0.10 wt % to 4.0 wt %.

Suitable alkoxylated nonionic surfactants include primary C₆-C₁₆ alcohol polyglycol ether i.e. ethoxylated alcohols having 6 to 16 carbon atoms in the alkyl moiety and 4 to 30 ethylene oxide (EO) units. When referred to for example C₉₋₁₄ it is meant average carbons and alternative reference to for example EO8 is meant average ethylene oxide units.

Suitable alkoxylated nonionic surfactants are according to the formula RO-(A)ₙH, wherein: R is a C₆ to C₁₈, preferably a C₈ to C₁₆, more preferably a C₈ to C₁₂ alkyl chain, or a C₆ to C₂₈ alkyl benzene chain; A is an ethoxy or propoxy or butoxy unit, and wherein n is from 1 to 30, preferably from 1 to 15 and, more preferably from 4 to 12 even more preferably from 5 to 10. Preferred R chains for use herein are the C₈ to C₂₂ alkyl chains. Even more preferred R chains for use herein are the C₉ to C₁₂ alkyl chains. R can be linear or branched alkyl chain.

Suitable ethoxylated nonionic surfactants for use herein are Dobanol® 91-2.5 (HLB=8.1; R is a mixture of C₉ and C₁₁ alkyl chains, n is 2.5), Dobanol® 91-10 (HLB=14.2; R is a mixture of C₉ to C₁₁ alkyl chains, n is 10), Dobanol® 91-12 (HLB=14.5; R is a mixture of C₉ to C₁₁ alkyl chains, n is 12), Greenbentine DE80 (HLB=13.8, 98 wt % C10 linear alkyl chain, n is 8), Marlipal 10-8 (HLB=13.8, R is a C10 linear alkyl chain, n is 8), Lialethl® 11-5 (R is a C₁₁ alkyl chain, n is 5), Isalchem® 11-5 (R is a mixture of linear and branched C11 alkyl chain, n is 5), Lialethl® 11-21 (R is a mixture of linear and branched C₁₁ alkyl chain, n is 21), Isalchem® 11-21 (R is a C₁₁ branched alkyl chain, n is 21), Empilan® KBE21 (R is a mixture of C₁₂ and C₁₄ alkyl chains, n is 21) or mixtures thereof. Preferred herein are Dobanol® 91-5, Neodol® 11-5, Lialethl® 11-21 Lialethl® 11-5 Isalchem® 11-5 Isalchem® 11-21 Dobanol® 91-8, or Dobanol® 91-10, or Dobanol® 91-12, or mixtures thereof. These Dobanol®/Neodol® surfactants are commercially available from SHELL. These Lutensol® surfactants are commercially available from BASF and these Tergitol® surfactants are commercially available from Dow Chemicals.

Suitable chemical processes for preparing the alkoxylated nonionic surfactants for use herein include condensation of corresponding alcohols with alkylene oxide, in the desired proportions. Such processes are well known to the person skilled in the art and have been extensively described in the art, including the OXO process and various derivatives thereof. Suitable alkoxylated fatty alcohol nonionic surfactants, produced using the OXO process, have been marketed under the tradename NEODOL® by the Shell Chemical Company. Alternatively, suitable alkoxylated nonionic surfactants can be prepared by other processes such as the Ziegler process, in addition to derivatives of the OXO or Ziegler processes.

Preferably, said alkoxylated nonionic surfactant is a C₉₋₁₁ EO5 alkylethoxylate, C₁₂₋₁₄ EO5 alkylethoxylate, a C₁₁ EO5 alkylethoxylate, C₁₂₋₁₄ EO21 alkylethoxylate, or a C₉₋₁₁ EO8 alkylethoxylate or a mixture thereof. Most preferably, said alkoxylated nonionic surfactant is a C₁₁ EO5 alkylethoxylate or a C₉₋₁₁ EO8 alkylethoxylate or a mixture thereof.

Alkyl polyglycosides are biodegradable nonionic surfactants which are well known in the art.

Suitable alkyl polyglycosides can have the general formula CₙH₂ₙ₊₁O(C₆H₁₀O₅)ₓH wherein n is preferably from 9 to 16, more preferably 11 to 14, and x is preferably from 1 to 2, more preferably 1.3 to 1.6. Such alkyl polyglycosides provide a good balance between anti-foam activity and detergency. Alkyl polyglycoside surfactants are commercially available in a large variety. An example of a very suitable alkyl poly glycoside product is Planteren APG 600, which is essentially an aqueous dispersion of alkyl polyglycosides wherein n is about 13 and x is about 1.4.

Suitable amine oxide surfactants include: R₁R₂R₃NO wherein each of R₁, R₂ and R₃ is independently a saturated or unsaturated, substituted or unsubstituted, linear or branched hydrocarbon chain having from 10 to 30 carbon atoms. Preferred amine oxide surfactants are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain. Preferably, the liquid hard surface cleaning composition comprises from 0.00025 wt % to 10.0 wt %, preferably from 0.001 wt % to 6.0 wt %, more preferably from 0.01 wt % to 3.0 wt % and most preferably from 0.1 wt % to 1.0 wt % of the composition of amine oxide surfactant.

A highly preferred amine oxide is C₁₂-C₁₄ dimethyl amine oxide, commercially available from Albright & Wilson, C₁₂-C₁₄ amine oxides commercially available under the trade name Genaminox® LA from Clariant or AROMOX® DMC from AKZO Nobel.

The nonionic surfactant is preferably a low molecular weight nonionic surfactant, having a molecular weight of less than 950 g/mol, more preferably less than 500 g/mol.

The liquid hard surface cleaning composition can comprise an anionic surfactant which can be selected from the group consisting of: an alkyl sulphate, a sulphonic acid or sulphonate surfactant, and mixtures thereof. The liquid hard surface cleaning composition can comprise from 0.05 wt % to 5.0 wt %, preferably from 0.1 wt % to 4.0 wt %, and most preferably from 0.2 wt % to 3.5 wt % of anionic surfactant.

Suitable alkyl sulphates for use herein include water-soluble salts or acids of the formula ROSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphates include C₁₂₋₁₄ alkyl sulphate like EMPICOL® 0298/, EMPICOL® 0298/F or EMPICOL® XLB commercially available from Huntsman. By “linear alkyl sulphate” it is meant herein a non-substituted alkyl sulphate wherein the linear alkyl chain comprises from 6 to 16 carbon atoms, preferably from 8 to 14 carbon atoms, and more preferably from 10 to 14 carbon atoms, and wherein this alkyl chain is sulphated at one terminus.

Suitable sulphonated anionic surfactants for use herein are all those commonly known by those skilled in the art. Preferably, the sulphonated anionic surfactants for use herein are selected from the group consisting of: alkyl sulphonates; alkyl aryl sulphonates; naphthalene sulphonates; and mixtures thereof.

Suitable alkyl sulphonates for use herein include water-soluble salts or acids of the formula RSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₁₈ linear or branched saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphonates include C₁₂-C₁₆ paraffin sulphonate like Hostapur® SAS commercially available from Clariant. Particularly preferred alkyl aryl sulphonates are alkyl benzene sulphonates commercially available under trade name Nansa® available from Huntsman.

By “linear alkyl sulphonate” it is meant herein a non-substituted alkyl sulphonate wherein the alkyl chain comprises from 6 to 18 carbon atoms, preferably from 8 to 16 carbon atoms, and more preferably from 10 to 16 carbon atoms, and wherein this alkyl chain is sulphonated at one terminus.

Suitable alkoxylated sulphonate surfactants for use herein are according to the formula R(A)ₘSO₃M, wherein R is an unsubstituted C₆-C₁₈ alkyl, hydroxyalkyl or alkyl aryl group, having a linear or branched C₆-C₁₈ alkyl component, preferably a C₈-C₁₆ alkyl or hydroxyalkyl, more preferably C₁₂-C₁₆ alkyl or hydroxyalkyl, and A is an ethoxy or propoxy or butoxy unit, and m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphonates, alkyl butoxylated sulphonates as well as alkyl propoxylated sulphonates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like.

Exemplary surfactants are Triton™ X-200 from DOW.

Suitable sulphated or sulphonated anionic surfactant for use herein include alkyl sulphates (AS) preferably C₁₂, C₁₃, C₁₄ and C₁₅ AS, sodium linear alkyl sulphonate (NaLAS), sodium paraffin sulphonate NaPC₁₂₋₁₆S, and mixtures thereof. Preferably the sulphated or sulphonated anionic surfactant is selected from the group consisting of alkyl sulphates (AS) preferably, C₁₂, C₁₃, C₁₄ and C₁₅ AS, sodium linear alkyl sulphonate (NaLAS), sodium paraffin sulphonate NaPC₁₂₋₁₆S and mixtures thereof. Most preferred are alkylbenzene sulfonates, especially C₁₂₋₁₄ alkylbenzene sulfonate.

Typically, the liquid composition herein may comprise from 0.05 wt % to 5.0 wt %, preferably from 0.1 wt % to 4.0 wt %, and most preferably from 0.2 wt % to 3.5 wt % of the total composition of said sulphated or sulphonated anionic surfactant.

In order to reduce foaming during use, the composition preferably comprises less than 6%, preferably less than 3%, more preferably less than 0.5% by weight of alkyl ether sulphate anionic surfactant.

The hard surface cleaning composition may comprise up to 3.0 wt % of an additional surfactant, preferably selected from: an amphoteric, zwitterionic, and mixtures thereof. More preferably, the hard surface cleaning composition can comprise from 0.005 wt % to 1.5 wt %, or from 0.001 wt % to 0.5 wt %, or from 0.0025 wt % to 0.25* wt % by weight of the additional surfactant.

Suitable zwitterionic surfactants typically contain both cationic and anionic groups in substantially equivalent proportions so as to be electrically neutral at the pH of use. The typical cationic group is a quaternary ammonium group, other positively charged groups like phosphonium, imidazolium and sulfonium groups can be used. The typical anionic hydrophilic groups are carboxylates and sulfonates, although other groups like sulfates, phosphonates, and the like can be used.

Some common examples of zwitterionic surfactants (such as betaine/sulphobetaine surfacants) are described in U.S. Pat. Nos. 2,082,275, 2,702,279 and 2,255,082. For example Coconut dimethyl betaine is commercially available from Seppic under the trade name of Amonyl 265®.

Lauryl betaine is commercially available from Albright & Wilson under the trade name Empigen BB/L®. A further example of betaine is Lauryl-imminodipropionate commercially available from Rhodia under the trade name Mirataine H2C-HA®.

Sulfobetaine surfactants are particularly preferred, since they can improve soap scum cleaning. Examples of suitable sulfobetaine surfactants include tallow bis(hydroxyethyl) sulphobetaine, cocoamido propyl hydroxy sulphobetaines which are commercially available from Rhodia and Witco, under the trade name of Mirataine CBS® and ReWoteric AM CAS 15® respectively.

Amphoteric surfactants can be either cationic or anionic depending upon the pH of the composition. Suitable amphoteric surfactants include dodecylbeta-alanine, N-alkyltaurines such as the one prepared by reacting dodecylamine with sodium isethionate, as taught in U.S. Pat. No. 2,658,072, N-higher alkylaspartic acids such as those taught in U.S. Pat. No. 2,438,091, and the products sold under the trade name “Miranol”, as described in U.S. Pat. No. 2,528,378. Other suitable additional surfactants can be found in McCutcheon's Detergents and Emulsifers, North American Ed. 1980.

Solvent:

The liquid hard surface cleaning composition can comprise a solvent, especially a non-aqueous solvent. The preferred solvents include propylene glycol n-butyl ether (dowanol PnB), tripropylene glycol methyl ether (dowanol TPM), dipropylene glycol n-propyl ether (dowanol DPnP), dipropylene glycol n-butyl ether (dowanol DPnB), tripropylene glycol n-butyl ether (dowanol TPnB), diethylene glycol n-butyl ether (Butyl carbitol), diethylene glycol hexyl ether (hexyl Carbitol), diethylene glycol n-butyl ether acetate (butyl carbitol acetate), ethylene glycol hexyl ether (hexyl cellosolve), triethylene glycol methyl ether (methoxytriglycol), triethylene glycol ethyl ether (ethoxytriglycol), triethylene glycol n-butyl ether (butoxytriglycol), Ucar filmer ibt, trimethylnonanol, propylene glycol diacetate (dowanol PGDA), dipropylene glycol methyl ether (dowanol DPM) mixtures thereof. Such solvents can be present at a level of from 0.005 wt % to 10 wt % by weight of the total composition of said solvent, preferably from 0.01 wt % to 7.0 wt %, more preferably from 0.025 wt % to 5.5 wt % and most preferably from 0.25 wt % to 3.0 wt %.

The combination of the solvent and hydrophobically modified cationic polymer results in a hard surface cleaning composition which is both low sudsing, and improves the loosening and removal of soils. It is believed that the combination of solvent and polymer also improves the distribution and deposition of the polymer onto the hard surface, and improves the wetting and emulsification of the soil off the treated surface.

Optional Ingredients:

Polymers: The liquid hard surface cleaning composition may comprise a polymer. It has been found that the presence of a specific polymer as described herein, when present, allows further improving the grease removal performance of the liquid composition due to the improved emulsification of the greasy soil. Suitable polymers for use herein are disclosed in co-pending EP patent application EP2272942 (09164872.5) and granted European patent EP2025743 (07113156.9).

The polymer can be selected from the group consisting of: ethoxylated alkoxylated nonionic polymeric surfactants (as described in EP 3 015 540 A2, paragraphs [0028] to [0036]), a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyvinylpyrrolidone/vinylimidazole copolymer (PVP-VI); a polyvinylpyrrolidone/polyacrylic acid copolymer (PVP-AA); a polyvinylpyrrolidone/vinylacetate copolymer (PVP-VA); a polyacrylic polymer or polyacrylicmaleic copolymer; and a polyacrylic or polyacrylic maleic phosphono end group copolymer; and mixtures thereof.

The liquid hard surface cleaning composition may comprise from 0.001 wt % to 2.25 wt % by weight of the total composition of said polymer, preferably from 0.0025 wt % to 2.0 wt %, more preferably from 0.01 wt % to 1.75 wt % and most preferably from 0.05 wt % to 1.5 wt %.

Thickener:

The liquid hard surface cleaning composition can comprise a thickener. An increased viscosity, especially low shear viscosity, provides longer contact time and therefore improved penetration of greasy soil and/or particulated greasy soil to improve cleaning effectiveness, especially when applied neat to the surface to be treated. Hence, preferably, the liquid hard surface cleaning composition, comprising a thickener, has a viscosity of from 50 Pa·s to 650 Pa·s, more preferably 100 Pa·s to 550 Pa·s, most preferably 150 Pa·s to 450 Pa·s, at 20° C. when measured with a AD1000 Advanced Rheometer from Atlas® shear rate 10 s⁻¹ with a coned spindle of 40 mm with a cone angle 2° and a truncation of ±60 μm.

Suitable thickeners include polyacrylate based polymers, preferably hydrophobically modified polyacrylate polymers; hydroxyl ethyl cellulose, preferably hydrophobically modified hydroxyl ethyl cellulose, xanthan gum, hydrogenated castor oil (HCO) and mixtures thereof.

Preferred thickeners are polyacrylate based polymers, preferably hydrophobically modified polyacrylate polymers. Preferably a water soluble copolymer based on main monomers acrylic acid, acrylic acid esters, vinyl acetate, methacrylic acid, acrylonitrile and mixtures thereof, more preferably copolymer is based on methacrylic acid and acrylic acid esters having appearance of milky, low viscous dispersion. Most preferred hydrologically modified polyacrylate polymer is Rheovis® AT 120, which is commercially available from BASF.

Other suitable thickeners are hydroxethylcelluloses (HM-HEC) preferably hydrophobically modified hydroxyethylcellulose. Suitable hydroxethylcelluloses (HM-HEC) are commercially available from Aqualon/Hercules under the product name Polysurf 76® and W301 from 3V Sigma.

Xanthan gum is one suitable thickener used herein. Xanthan gum is a polysaccharide commonly used rheoligy modifier and stabilizer. Xanthan gum is produced by fermentation of glucose or sucroce by the xanthomonas campestris bacterium. Suitable Xanthan gum is commercially available under trade name Kelzan T® from CP Kelco.

Hydrogenated castor oil is one suitable thickener used herein. Suitable hydrogenated castor oil is available under trade name THIXCIN R from Elementis.

The most preferred thickener used herein is a modified methacrylic acid/acrylic acid copolymer Rheovis® AT 120, which is commercially available from BASF.

When used, the liquid hard surface cleaning composition comprises from 0.1% to 10.0% by weight of the total composition of said thickener, preferably from 0.2% to 5.0%, more preferably from 0.2% to 2.5% and most preferably from 0.2% to 2.0%.

Chelating agent: The liquid hard surface cleaning composition can comprise a chelating agent or crystal growth inhibitor. Suitable chelating agents, in combination with the surfactant system, improve the shine benefit. Chelating agent can be incorporated into the compositions in amounts ranging from 0.005% to 5.0% by weight of the total composition, preferably from 0.01% to 3.0%, more preferably from 0.02% to 2.0% and most preferably from 0.05% to 0.4%.

Suitable phosphonate chelating agents include ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agent to be used herein is diethylene triamine penta methylene phosphonate (DTPMP). Such phosphonate chelating agents are commercially available from Monsanto under the trade name DEQUEST®.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename (S,S)EDDS® from Palmer Research Laboratories. Most preferred biodegradable chelating agent is L-glutamic acid N,N-diacetic acid (GLDA) commercially available under tradename Dissolvine 47S from Akzo Nobel.

Suitable amino carboxylates for use herein include ethylene diamine tetra acetates, diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanoldiglycines, and methyl glycine diacetic acid (MGDA), both in their acid form, or in their alkali metal, ammonium, and substituted ammonium salt forms. Particularly suitable amino carboxylate to be used herein is propylene diamine tetracetic acid (PDTA) which is, for instance, commercially available from BASF under the trade name Trilon FS® and methyl glycine di-acetic acid (MGDA). Most preferred aminocarboxylate used herein is diethylene triamine pentaacetate (DTPA) from BASF. Further carboxylate chelating agents for use herein include salicylic acid, aspartic acid, glutamic acid, glycine, malonic acid or mixtures thereof.

Suitable fatty acids include the alkali salts of a C₈-C₂₄ fatty acid. Such alkali salts include the metal fully saturated salts like sodium, potassium and/or lithium salts as well as the ammonium and/or alkylammonium salts of fatty acids, preferably the sodium salt. Preferred fatty acids for use herein contain from 8 to 22, preferably from 8 to 20 and more preferably from 8 to 18 carbon atoms. Suitable fatty acids may be selected from caprylic acid, capric acid, lauric acid, myristic acid, palmitic acid, stearic acid, oleic acid, and mixtures of fatty acids suitably hardened, derived from natural sources such as plant or animal esters (e.g., palm oil, olive oil, coconut oil, soybean oil, castor oil, tallow, ground oil, whale and fish oils and/or babassu oil. For example coconut fatty acid is commercially available from KLK OLEA under the name PALMERAB 1211.

Typically, the liquid hard surface cleaning composition may comprise up to 6.0% by weight of the total composition of said fatty acid, preferably from 0.1% to 3.0%, more preferably from 0.1% to 2.0% and most preferably from 0.15% to 1.5% by weight of the total composition of said fatty acid.

Typically, the liquid hard surface cleaning composition may comprise up to 2.0% by weight of the total composition of said branched fatty alcohol, preferably from 0.10% to 1.0%, more preferably from 0.1% to 0.8% and most preferably from 0.1% to 0.5%.

Perfumes:

The liquid hard surface cleaning compositions preferably comprise a perfume. Suitable perfumes provide an olfactory aesthetic benefit and/or mask any “chemical” odour that the product may have.

Methods:

A) pH Measurement:

The pH is measured on the neat composition, at 25° C., using a Sartarius PT-10P pH meter with gel-filled probe (such as the Toledo probe, part number 52 000 100), calibrated according to the instructions manual.

B) Polymerised Grease Cleaning:

White enamel tiles (7 cm×25 cm, supplied by Emaillerie Belge SA) are used in this method. The tiles are soaked in a diluted All Purpose Cleaning composition which is free of surface modification polymers (such as current market European Mr. Propre APC liquid diluted to 2.4 volume %) overnight and rinsed thoroughly the day after with demineralised water to remove all product residues. The tiles are then completely dried.

In order to provide the soil mix, mix 9.8 g of oil mix (by weight, ⅓ peanut oil, ⅓ sunflower oil, ⅓ corn oil of Belgian brand ‘Vandemoortele’) and 0.2 g of HSW (Housewife Soil with Carbon Black supplied by Chem-Pack, 2261 Spring Grove Avenue, Cincinnati Ohio 45214 USA) in a 50 mL beaker for 15 minutes using a magnetic stirrer to ensure a homogeneous mixture.

Weigh each tile. Cut out the edge of a 7 ml pipette and sample around 3 to 4 ml of the soil mix. Pour the soil mix evenly onto 10 tiles. Repeat twice the sampling and pouring of soil mix.

Without squeezing, brush a paint roller (7 cm length, 6 cm diameter, made from synthetic sponge) to remove any remaining particles. With firm pressure, roll the soil in a vertical motion over the tile, then roll horizontally over the tiles. Finish with a gentle vertical roll to ensure the soil has evenly spread. Weigh each tile again and calculate the difference in mass in order to find the weight of soil mix applied to each tile. The total mass of soil mix per tile must be 0.6 g+/−0.1 g. If less than 0.5 g, add soil mix and roll once more to form a thin even layer. If the mass of soil mix per tile is greater than 0.7 g, start all over using a new tile.

Preheat an oven to 135° C. for enamel. The soil mix is polymerized by baking the tiles at 135° C. for 3 hours and 10 mins. Once the baking time has been reached, remove the tiles from the oven and cool them overnight in a controlled temperature/humidity cabinet (25° C./70% relative humidity).

Rinse sponges (yellow cellulose sponges. Type Z, supplied by Boma, Noorderlaan 131, 2030 Antwerpen) under running tap city water and squeeze out. The weight of the four squeezed sponge should be the same (+/−2 g). Pour 5 ml of liquid hard surface cleaning composition with a pipette onto the sponge.

Applying uniform pressure of 1.4 kN/m², wipe the tile in a linear motion over the tile at a frequency of 20 strokes per minute. This is preferably done using a mechanical apparatus which applies uniform pressure while wiping over the tile length at the defined number of cycles per minute. The number of strokes required to clean the tile is counted. The cleaning test is repeated at least eight times and the result averaged.

The polymerized grease cleaning index is calculated relative to the reference as follows:

$$\frac{\begin{matrix}Av . number of strokes to clean \\ the tile using the composition\end{matrix}}{\begin{matrix}Av . number of strokes to clean \\ the tile using the reference composition\end{matrix}} \times 100$$

Hence, a lower grade indicates improved polymerized grease cleaning.

C) Shine:

The shine test is done with a soil mixture which consists of a mixture of consumer relevant soils such as oil, polymerized oil, particulates, pet hair, granulated sugar etc. The black glossy ceramic tiles (Black Glossy Sphinx ceramic tiles 20×25 cm, Ref H07300, available at Carobati, Boomsesteenweg 36, 2630 Aartselaar www.carobati.be) are soiled with 0.03 g soil mixture (18.01 wt % Crisco oil [purchased from a North American supermarket], 2.08 wt % of polymerized Crisco oil [polymerized by pumping air at 1 PSI (0.0689 bar) through 500 g of Crisco oil in a 2 L beaker, while stirring at 125 rpm on a hot-plate set at 204° C. for 67 hours, before covering with an aluminium foil and leaving at 204° C. for an additional 30 hours, then cooling to room temperature with hot-plate turned off for 64 hours before heating at 204° C. for 64 hours, before cooling at room temperature with the hot-plate turned off for an additional 24 hours, so that the final viscosity of the oil is between 1800 and 2200 cps, when measured using a Brookfield DVT with spindle nr. 31 at 6 rpm], 28.87 wt % of granulated sugar, and 51.04 wt % of vacuum cleaner soil [“Vacuum Cleaner Soil” supplied by Chem-Pack, 2261 Spring Grove Avenue, Cincinnati Ohio 45214 USA]) by blending the soil mixture with isopropyl alcohol at 1.45 wt % and spraying onto the tile. The tiles are then cleaned with the diluted liquid hard surface cleaning composition(s) and, after letting the tiles dry, the tiles are assessed using the grading scale described below.

Shine Grade:
0=as new/no streaks and/or film
1=very slight streaks and/or film
2=slight streaks and/or film
3=slight to moderate streaks and/or film
4=moderate streaks and/or film
5=moderate/heavy streaks and/or film
6=heavy streaks and/or film

Hence, a lower grade indicates improved shine.

### EXAMPLES

The following compositions were prepared by simple mixing:

| % active by weight of | Ex A* | Ex 1 | Ex 2 | Ex 3 |
|---|---|---|---|---|
| the composition | wt % | wt % | wt % | wt % |
| C10 EO8¹ | 3.00 | 3.00 | 3.00 | 3.00 |
| C12-14 dimethyl amine | 0.15 | — | — | — |
| oxide² | | | | |
| Amine 1³ | — | 0.15 | — | — |
| Amine 2⁴ | — | — | 0.15 | — |
| Amine 3⁵ | — | — | — | 0.15 |
| HLAS | 0.45 | 0.45 | 0.45 | 0.45 |
| Citric Acid | 0.30 | 0.30 | 0.30 | 0.30 |
| NaOH | 0.22 | 0.22 | 0.22 | 0.22 |
| Sodium carbonate | 0.40 | 0.40 | 0.40 | 0.40 |
| DTPMP⁶ | 0.10 | 0.10 | 0.10 | 0.10 |
| pH (neat at 20° C.) - | 10.30 | 10.30 | 10.30 | 10.30 |
| with NaOH | | | | |
| Water and minors (dye, | To 100% | To 100% | To 100% | To 100% |
| perfume, preservative) | | | | |

*comparative
¹nonionic surfactant commercially available from Shell.
²amine oxide nonionic surfactant commercially available from Huntsman
³Amine of formula III, wherein R1 is CH2—(CHOH)4—CH2OH, R2 is Methyl, and R3 is 2-propylheptyl; The amine of formula III was made by reacting 2-propylheptyl derived alkyl glycydyl ether (2-((2-propylheptyl)oxy)oxirane) with N-methyl glucamine. The 2-propylheptyl derived alkyl glycydil ether is made by adding epichlorohydrin to the 2-propylheptyl alcohol in the presence of a stannic chloride catalyst at 60° C. to yield the crude ether. Water and caustic are added to form the finished ether. The 2-propylheptyl derived alkyl glycydyl ether is then purified by decanting the top layer, drying under nitrogen and filtering. The N-methyl glucamine is added to methanol under stirring to form a suspension, to which is added the 2-propylheptyl derived alkyl glycydil ether, with the mixture stirred at 55° C. for 6-24 hours. The methanol is then evaporated away to yield the amine of formula I (6-((2-hydroxy-3-((2-propylheptyl)oxy)propyl)(methyl)amino)hexane-1,2,3,4,5-pentaol).
⁴Amine of formula I, wherein R1 is derived from glucose with formula —CH2—(CHOH)4—CH2OH, R2 is methyl and R3 is n-octyl (N-methyl N-octyl glucamine); The amine of formula I was made by using the following procedure: 135 g of N-methylglucamine (NMG), 100 g of 1-bromooctane and 600 mL of methanol was stirred for 24 hours at 45-50° C. under nitrogen. The resultant solution was reduced in volume to 400 ml by evaporation with a vigorous stream of dry nitrogen through the solution, and stirred for 48 hours at between 40 and 50° C. 117.5 g of 25 wt % sodium methoxide in methanol was added and the resultant mixture stirred for 1 hour at 40° C., before being evaporated to 250 mL. The solution was added to 750 ml of deionized water at room temperature and stirred for 10 minutes and allowed to stand for 1 hour. The mixture was kept at −4° C. for 2 hours yielding a white precipitate which was collected by filtration, rinsed twice with chilled water and once using chilled methanol. The precipitate was partially dried in air overnight to 262 g before being dissolved in 600 mL ethanol at 35° C. The resulting solution kept at −4° C. for 4 hours, yielding a white precipitant which was collected by filtration, rinsed twice in ethanol at 10° C., before being dried in air overnight and 24 hours in a vacuum oven at room temperature to 87.2 g of white solid having 99% purity (measured by GC).
⁵Amine of formula III, wherein R1 is CH2—(CHOH)4—CH2OH, R2 is Methyl, and R3 is 2-ethylhexyl; The amine was made in the same manner as described above, except that 2-ethylhexyl alcohol was used instead of 2-propylheptyl alcohol.
⁶diethylenetriamine penta(methylene phosphonic acid), commercially available from Zschinmer & Schwarz, Mohsdorf

The polymerized grease cleaning and shine results from the above examples is given in the table below. As can be seen from the results, the compositions of use in the method of the present invention, comprising the amines, result in easier removal of polymerized grease and improved shine, in comparison to the example A, which comprised an amine oxide surfactant:

| | Exam- | | | |
|---|---|---|---|---|
| | ple A | | | |
| | (compar- | Exam- | Exam- | Exam- |
| | ative) | ple 1 | ple 2 | ple 3 |
| Polymerized grease cleaning | 100 | 117 | 114 | 118 |
| index | | | | |
| Dilute soiled shine grade | 2.50 | 1.88 | 2.00 | 1.00 |

The following are examples of liquid hard surface cleaning compositions of use in the method of the present invention:

| | Ex 4 | Ex 5 | Ex 6 | Ex 7 | Ex 8 | Ex 9 | Ex 10 | Ex 11 | Ex 12 |
|---|---|---|---|---|---|---|---|---|---|
| | wt % | wt % | wt % | wt % | wt % | wt % | wt % | wt % | wt % |
| C9/11 EO8¹ | 3.0 | — | — | 3.2 | 2.0 | 4.10 | — | — | — |
| C9/11EO5⁷ | — | 6.2 | — | 2.8 | — | — | 2.4 | — | 1.0 |
| C13/15 EO30⁸ | 3.0 | — | — | — | — | — | — | — | 0.2 |
| C8/10 EO8⁹ | — | — | 6.0 | — | — | — | — | 1.45 | — |
| NaLAS¹⁰ | 2.64 | 1.8 | 2 | 2 | — | 1.76 | — | 0.22 | — |
| NAPS¹¹ | — | — | — | — | 0.1 | — | 0.36 | — | 0.22 |
| C12-14 Amine | 0.36 | 1.5 | 1 | — | — | 0.24 | — | 0.07 | — |
| Oxide² | | | | | | | | | |
| C12-14 Betaine¹² | — | — | — | 1.5 | 0.3 | — | 0.12 | — | 0.07 |
| Amine 3⁵ | — | 2.0 | — | 2.0 | — | — | — | — | 0.5 |
| Amine 4¹³ | 2.0 | — | — | — | 0.3 | — | — | — | — |
| Amine 5¹⁴ | — | — | 2.0 | — | — | — | 0.2 | — | — |
| Amine 6¹⁵ | — | — | — | — | — | 2.0 | — | 0.5 | — |
| Plurafac LF7319¹⁶ | 0.2 | — | — | 0.1 | — | — | — | — | 0.1 |
| Hydrophobically | 0.7 | — | — | 0.75 | — | 0.8 | — | — | — |
| modified- | | | | | | | | | |
| polyacrylate¹⁷ | | | | | | | | | |
| HM-HEC¹⁸ | — | 1.0 | — | — | — | — | — | — | — |
| Xanthan gum¹⁹ | — | — | 0.5 | — | — | — | — | — | — |
| Na₂CO₃ | 0.25 | 0.75 | 0.3 | 0.3 | 0.4 | 0.55 | 0.3 | 0.50 | 0.3 |
| Citric Acid | 0.1 | 0.2 | 0.3 | 0.3 | 0.3 | 0.3 | 0.2 | 0.3 | 0.2 |
| Caustic | 0.80 | 0.73 | 0.75 | — | 0.18 | 0.73 | 0.15 | 0.25 | 0.20 |
| Monoethanolamine | — | 0.5 | — | — | 0.25 | — | — | 0.5 | — |
| Aminomethyl | — | — | 0.1 | — | — | — | — | — | 0.5 |
| propanol²⁰ | | | | | | | | | |
| TPK Fatty Acid | 0.5 | 0.3 | 0.2 | 0.1 | — | 0.3 | 0.1 | 0.07 | 0.10 |
| 2-butyl octanol²¹ | — | 0.1 | — | — | — | — | — | — | — |
| 2-hexyl decanol²² | — | — | 0.2 | — | — | — | — | — | — |
| DTPMP⁶ | — | — | — | — | — | 0.3 | — | — | — |
| DTPA²³ | 0.3 | — | — | 0.2 | — | — | — | — | 0.1 |
| GLDA²⁴ | — | 0.25 | — | — | — | — | 0.2 | — | — |
| IPA²⁵ | — | — | 0.4 | — | — | — | — | — | — |
| n-BPP²⁶ | — | 1 | 2 | 0.8 | — | — | — | — | — |
| n-BP²⁷ | 2 | 1 | — | 0.7 | — | — | 0.5 | — | 0.2 |
| Minors and water | to | to | to | to | to | to | to | to | to |
| | 100% | 100% | 100% | 100% | 100% | 100% | 100% | 100% | 100% |
| pH | 10.8 | 10.3 | 10.3 | 9.5 | 10.8 | 10.3 | 9.5 | 10.8 | 11.3 |

⁷nonionic surfactant commercially available from ICI or Shell.
⁸nonionic surfactant commercially available from BASF
⁹nonionic surfactant commercially available from Sasol
¹⁰sodium linear alkylbenzene sulphonate commercially available from Huntsman
¹¹sodium paraffin sulphonate commercially available from ICS
¹²amphoteric surfactant commercially available from MC Intyre group
¹³N-hydroxyethyl glucamine, an amine of formula (II), wherein R1 is derived from glucose with formula —CH2—(CHOH)4—CH2OH, R2 is hydrogen and R3 is hydroxyethyl. N- hydroxyethyl glucamine was made using the following procedure: To D-glucose (27.5 g) was added methanol (20 ml) followed by ethanol amine (10.25 ml). This was stirred for 5 minutes before water (10 ml) was added and the mixture stirred an additional 10 minutes. 5% Pd—C (0.98 g) was added to a vial followed by ~ 2 ml of water, and ~10 ml of methanol, before the blend was transferred under a N₂ stream to 160 mL Parr reactor using a minimum of methanol. The D-glucose/ethanol amine mixture was added to the Parr reactor and the reactor sealed. The reactor was degassed by pressurizing and venting 3 times using N₂ at 400 PSI. The reactor was then pressurized and vented 2X with 400 PSI H₂ then pressurized to 410 PSI and held. After 2 hour the reactor was heated to 50° C. then pressurized to 500 PSI. H₂ was added as need and the reaction was cooled to room temp when H₂ was no longer being consumed. The reactor was sparged 3 times using 400 PSI N₂. The product was filtered through 0.45 μm PTFE syringe filters to yield a clear solution. The solvent was removed using rotary evaporation. The product was crystallized from ethanol, collected by filtration and dried under high vacuum to yield a white solid having 95% purity (confirmed via NMR and GC).
¹⁴N-hexylglucamine is an amine of formula (I), wherein R1 is derived from glucose with formula —CH2—(CHOH)4—CH2OH, R2 is hydrogen and R3 is hexyl. The N-hexylglucamine was made using the following procedure: A 600 ml Parr reactor was charged with Raney nickel (10.8 g) and water (40 g). The reactor was sealed, purged three times with 300 PSI N₂ followed by three times with 300 PSI H₂. The reactor was then charged with 400 PSI H₂, and heated to 100-110° C. for 1 hr. The reactor and contents were cooled to room temperature and vented to ~100 PSI. Next, D-glucose was added (180 g of 40% aqueous solution, 72.1 g glucose, 400 mmoles) followed by hexyl amine (97.1 g of 50% solution in methanol, 48.6 grams, 480 mmoles) via an HPLC pump at room temperature. Reactor was charged to 450 PSI H₂ and then heated to 35° C. for 18 hrs, 50° C. for 1 hr, 75° C. for 1 hr and finally 100° C. for 1 hr during which time pressure was maintained at 300-500 PSI H₂. The reactor was cooled to ambient temperature, vented and purged three times with 300 PSI N₂. The hexylglucamine was then purified under N₂, by adding two volumes of MeOH and heating the mixture to around 55° C. to dissolve all the organic solids leaving suspended catalyst. Catalyst was filtered out under N₂ and the filtered liquids where allowed to cool and a precipitate formed. The precipitate was collected via vacuum filtration to yield after drying, 63 grams N-hexylglucamine at 98% purity via GC. The liquid filtrate was stripped and refrigerated. Additional product was precipitated and collected by vacuum filtration to yield after drying 18 grams at 99% purity.
¹⁵N,N-dimethyl glucamine, an amine of formula (II), supplied by Clariant under the trade name of Genamin ™ Gluco 50.
¹⁶Plurafac LF7319, ethoxylated-propoxylated ester, supplied by BASF
¹⁷Rheovis AT 120 thickener commercially available from BASF
¹⁸Hydrophobically modified hydroxyethylcellulose (cetylhydroxethylcellulose)
¹⁹Supplied by CP Kelco
²⁰Supplied by Dow Chemicals
²¹Supplied by Sasol as Isofol 12 ®.
²²Supplied by Sasol as Isofol 16 ®.
²³Diethylenetriaminepentaacetic acid, Trilon ®, supplied by BASF
²⁴Tetrasodium glutamate diacetate, supplied by Akzo Nobel
²⁵Isopropanol, commercially available from J T Baker
²⁶Butoxy propoxy propanol, commercially supplied by Dow Chemicals
²⁷Normal butoxy propanol commercially supplied by Dow Chemicals

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for cleaning household surfaces, the method comprising the steps of:
(a) optionally diluting an aqueous hard surface cleaning composition;
(b) applying the hard surface cleaning composition to the household surface; and
(c) optionally rinsing and/or wiping the surface;
wherein the aqueous hard surface cleaning composition comprises an amine selected from the group consisting of:
i. an amine of formula I:
R1-N—R2R3 formula I
wherein:
R1 is a cyclic or acyclic polyhydroxyhydrocarbyl;
R2 is hydrogen or methyl; and
R3 is a C6 to C30 hydrocarbyl;
ii. an amine of formula II:
R1-N—R2R3 formula II
wherein:
R1 is an acyclic or cyclic polyhydroxyhydrocarbyl; and
R2 and R3 are independently selected from:
hydrogen, wherein R2 and R3 are not both hydrogen;
substituted or unsubstituted C1 to C3 hydrocarbyl; and
acyclic or cyclic polyhydroxyhydrocarbyl as defined for R1;
iii. an amine of formula III:
R1-N—(R2)(CH2CHOH(CH2O)nR3) formula III
wherein:
R1 and R2 are independently selected from hydrogen, cyclic or acyclic, linear or branched C1 to C10 alkyl, C1 to C10 hydroxyalkyl, polyhydroxyhydrocarbyl and polyalkoxy of formula (R4-O)xH with R4 being C1-C4 and x is from about 1 to about 15;
n is about 0 or about 1; and
R3 is a C6 to C30 hydrocarbyl;
iv. and mixtures thereof.

2. The method of cleaning household surfaces according to claim 1, wherein the composition comprises an amine of formula I, wherein in said amine, R1 is a polyhydroxyhydrocarbyl derived from a sugar,

3. The method according to claim 2, wherein in said amine, R1 is a polyhydroxyhydrocarbyl derived from a sugar, selected from: a monosaccharide such as glucose, xylose, fructose or sorbitol; a disaccharide such as maltose or sucrose; or a higher oligosaccharide,

4. The method according to claim 3, wherein in said amine, R1 is a polyhydroxyhydrocarbyl derived from glucose.

5. The method of cleaning household surfaces according to claim 2, wherein in said amine of formula I, R3 is selected from the group consisting of linear and branched C6 to C30.

6. The method of cleaning household surfaces according to claim 5, wherein in said amine of formula I, R3 is selected from the group consisting of linear and branched C8 to C16.

7. The method of cleaning household surfaces according to claim 2, wherein the amine of formula I is selected from the group consisting of: N-octylglucamine, N,N-methyl octylglucamine, N-decylglucamine, N,N-methyl decylglucamine, N-2-ethylhexyl glucamine, N,N-2-ethylhexyl methylglucamine, N-2-propylheptyl glucamine, N,N-2-propylheptyl methyl glucamine, N-hexylglucamine, N,N-methyl hexylglucamine and mixtures thereof.

8. The method of cleaning household surfaces according to claim 1, wherein the composition comprises an amine of formula II, wherein R1 is a polyhydroxyhydrocarbyl derived from a sugar, particularly a monosaccharide such as glucose, xylose, fructose or sorbitol; a disaccharide such as maltose or sucrose; or a higher oligosaccharide.

9. The method of cleaning household surfaces according to claim 8, wherein in said amine of formula II, R2 and R3 are independently selected from the group consisting of hydrogen, C1 to C3 alkyl, C1 to C3 hydroxyalkyl, and C1 to C3 alkoxyalkyl.

10. The method according to claim 9, wherein R2 and R3 are independently selected from the group consisting of 2-ethoxyethyl and 3-ethoxypropyl, propoxy and mixtures thereof.

11. The method of cleaning household surfaces according to claim 2, wherein the amine of formula II is selected from the group consisting of: of N-methyl amino propane diol, N,N-dimethyl amino propane 1,2-diol, N-methylxylamine, N-methylmaltamine, glucosamine, N-methylglucamine, N,N-dimethylglucamine, N-ethylglucamine, N,N-diethylglucamine, N-methoxypropylglucamine, N-2-hydroxyethylglucamine, N, N-methyl 2-hydroxyethylglucamine, and mixtures thereof.

12. The method of cleaning household surfaces according to claim 1, wherein the composition comprises an amine of formula III, wherein in said amine, R1 is a polyhydroxyhydrocarbyl derived from a sugar.

13. The method of cleaning household surfaces according to claim 12, wherein in the amine of formula III, R1 is a polyhydroxyhydrocarbyl which is derived from a monosaccharide, and has the formula:
—CH2-(CHOH)4-CH2OH formula IIIa.

14. The method of cleaning household surfaces according to claim 12, wherein in said amine of formula III, R2 is selected from the group consisting of: hydrogen and C1 to C10 alkyl.

15. The method of cleaning household surfaces according to claim 12, wherein in said amine of formula III, R3 is selected from the group consisting of: C6 to C10 alkyl and mixtures thereof.

16. The method according to claim 15, wherein in said amine of formula III, R3 is selected from the group consisting of: 2-propylheptyl, 2-ethylhexyl, and mixtures thereof.

17. The method of cleaning household surfaces according to claim 1, wherein the composition comprises from 0.1% to 10% by weight of the composition of the amine.

18. The method of cleaning household surfaces according to claim 1, wherein the composition comprises detersive surfactant at a level of from about 0.00025 wt % to about 20 wt % of the composition.

19. The method of cleaning household surfaces according to claim 18, wherein the composition comprises from about 0.00025 wt % to about 20 wt % by weight of the total composition of nonionic surfactant.

20. The use of an amine selected from the group consisting of:
i. an amine of formula I:
R1-N—R2R3 formula I
wherein:
R1 is a cyclic or acyclic polyhydroxyhydrocarbyl;
R2 is hydrogen or methyl; and
R3 is a C6 to C30 hydrocarbyl;
ii. an amine of formula II:
R1-N—R2R3 formula II
wherein:
R1 is an acyclic or cyclic polyhydroxyhydrocarbyl; and
R2 and R3 are independently selected from:
hydrogen, wherein R2 and R3 are not both hydrogen;
substituted or unsubstituted C1 to C3 hydrocarbyl; and
acyclic or cyclic polyhydroxyhydrocarbyl as defined for R1;
iii. an amine of formula III:
R1-N—(R2)(CH2CHOH(CH2O)nR3) formula III
wherein:
R1 and R2 are independently selected from hydrogen, cyclic or acyclic, linear or branched C1 to C10 alkyl, C1 to C10 hydroxyalkyl, polyhydroxyhydrocarbyl and polyalkoxy of formula (R4-O)xH with R4 being C1-C4 and x is from about 1 to about 15;
n is about 0 or about 1; and
R3 is a C6 to C30 hydrocarbyl;
iv. and mixtures thereof;
in an aqueous hard surface cleaning composition, for removing grease from household surfaces and/or improving the shine of household surfaces.
